(19) United States
(12) Patent Application Publication
(10) Pub. No.: US 2022/0250823 A1
(43) Pub. Date: Aug. 11, 2022

(54) Integrated container and dunnage

(71) Applicants: Zhi An, Bellevue, WA (US); Joy An, Bellevue, WA (US)

(72) Inventors: Zhi An, Bellevue, WA (US); Joy An, Bellevue, WA (US)

(21) Appl. No.: 17/233,719

(22) Filed: Apr. 19, 2021

Related U.S. Application Data
(60) Provisional application No. 63/146,591, filed on Feb. 6, 2021.

(51) Int. Cl. B65D 81/05; F16K 15/20

(52) U.S. Cl. CPC B65D 81/052; F16K 15/20

(57) ABSTRACT

A container with integrated dunnage comprises a box fabricated from sheet container material such as cardboard. Adhering to interior walls of the box are one or more inflatable balloons fabricated from flexible, relatively inelastic sheet material. The balloons, when inflated, serve as dunnage for items in the box. An item for storage or shipment may be placed in the box prior to inflating the dunnage. The dunnage may deflated for removal of the item. After dunnage is deflated, the container with inflatable dunnage may be reused for storage or shipment.

### BACKGROUND OF THE INVENTION

### Field of the Invention

This invention relates to containers such as cardboard boxes for shipping. More specifically, this invention relates to such containers having dunnage for the shipment of items.

### Description of the Related Art

When items are shipped in containers such as cardboard boxes, they are often packaged with added dunnage. Dunnage in general is lightweight material added to the container simply for the purpose of retaining and cushioning the contents of the container. Because the overall weight of a package often factors into the cost of shipping, dunnage is generally of a lightweight material. And, because the dunnage has no value in the shipping transaction, it is preferred that dunnage be effective at the lowest possible cost.

Exemplary dunnage added to shipping containers have comprised crumpled paper, excelsior made of paper or wood fiber, beads of plastic such as Styrofoam®, and inflated plastic dunnage bags. All of these forms of dunnage in current use share a number of disadvantages.

One disadvantage hitherto is that, for many forms of prior art dunnage, the dunnage must be chosen and placed in a way that is specific to the configuration of the shipped item. While fill materials such as beads and excelsior address this problem, difficulties in removing and disposing such diffuse material present a disadvantage to their use. Plastic sheeting with inflatable air cells, such as described in U.S. Publication No. 20020134049A1 by Simahee, may be used advantageously as dunnage, its integrity permitting relatively easy removal from the shipping container. Such dunnage, however, must be chosen and placed in a way that is specific to the configuration of the container and the shipped item.

An approach to using a dunnage that configures to the container and the shipped item is to use inflatable air bags or balloons, such as described in U.S. Publication Nos. 20010001921A1 and 20070172326A1 by Sperry et al., in which an inflatable bag is inserted in an assembled container holding the item to be shipped. The bag is then inflated to press against the item and hold it in place for shipment. As with the sheets of air cells, the integrity of the inflatable bag permits relatively easy removal from the shipping container.

However, disadvantages of all these related art dunnage technologies include the fact that the shipper must insert and install the dunnage in the shipping container with each shipped item. Further, after the container with the item has been received at its destination by the recipient, the dunnage must be removed and disposed of by the recipient. In the case of much dunnage in current use, particularly the widely used plastic beads and inflated plastic bags, disposal of dunnage poses significant environmental burdens.

What is needed is a form of dunnage that is integral to each shipping container, needing neither insertion on shipment nor removal on delivery. What is needed further is a single form of dunnage that configures to every shipped item regardless of item configuration. What is needed further is such a form of dunnage that, because it does not need to be removed and disposed of by the recipient, enables easy reuse of the shipping container with dunnage.

### SUMMARY OF THE INVENTION

A container with integrated dunnage comprises a box fabricated from sheet container material such as cardboard. On at least one interior wall of the box is adhered at least one inflatable balloon fabricated from flexible, relatively inelastic sheet material such as Mylar®. The balloon, when inflated, serves as dunnage for items shipped in the box. In some embodiments, protruding from the exterior through the wall to which the balloon adheres and communicating with the interior of the balloon is a valve stem permitting the balloon to be inflated and deflated from the outside of the box. Within the valve stem is a valve serving releasably to retain gas within the balloon.

In other embodiments, one or more means for inflating the adhered balloon may be integral to the container. Such integral means may be a small air pump which in some embodiments may be manually operated and in other embodiments may be powered by battery or other source of power. Alternatively or additionally, such integral means for inflating may comprise a replaceable or refillable container of compressed gas. In such embodiments, a valve also is provided releasably to retain gas within the balloon. For the release of the inflating dunnage gas, such valve may be accessible from the box exterior or, in other embodiments, the valve is operably accessible in the interior of the box prior to deflation of the inflated dunnage.

Some embodiments have only a single balloon attached to one interior wall of the box. Other embodiments have a plurality of balloons adhering to one or more interior walls of the box. Some embodiments may have a single point for inflation and deflation of the dunnage. Other embodiments may have a plurality of points for inflation and deflation.

In some embodiments, in addition to the dunnage balloon, a rigid or semi-rigid member may be attached to the dunnage balloon distal the wall to which the dunnage balloon is attached. In some such embodiments, this member may be configured or molded to receive and retain an item with a specific configuration. In use, the inflated dunnage presses the member against the item it is configured to receive, thereby restraining the item for shipment.

Embodiments may be fabricated in a flat sheet as for a conventional shipping box. In embodiments with a protruding valve stem, a valve stem opening is cut in the sheet for each dunnage balloon to be used. Prior to assembly into a box, the deflated dunnage balloon or balloons are adhered to the box, placed so that the valve stem protrudes through the valve stem openings cut in the box. The box sheet material with integral inflatable dunnage may be shipped and stored for later assembly into a box.

In embodiments in use, an item for shipping is placed in an assembled box with deflated dunnage. The dunnage is then inflated, either prior to or after sealing the box. In embodiments having a protruding valve stem, the dunnage balloon is inflated with compressed gas passed into the valve stem. In embodiments with an air pump, the user simply operates the pump to provide sufficient air to inflate the balloon. In embodiments relying on a container of compressed gas, the user releases the gas from the container into the dunnage balloon to inflate it. In any case, the dunnage balloon is sufficiently inflated so as to retain, restrain and protect the item being shipped. On receipt, the recipient can deflate the dunnage through the valve provided for such purpose, either before or after opening the box, and retrieve the item. The box with attached dunnage may then be reused for other shipments.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a perspective view of an embodiment of the invention in an unassembled container with uninflated integral dunnage;

FIG. 2 is a perspective view of an assembled container with integral inflated dunnage containing an item for shipment;

FIG. 3 is a detailed diagram of an embodiment in which a valve for filling dunnage protrudes through a hole in the side of the container, the valve shown in a closed position;

FIG. 4 is a diagram of an embodiment as in FIG. 3, the valve shown open by way of an inserted fill/discharge tube;

FIG. 5a is a cut-away depiction of an embodiment of the invention that uses an internal air pump to inflate the dunnage, shown here holding an item with the integral dunnage uninflated;

FIG. 5b is a cut-away depiction of the embodiment shown in FIG. 5a, shown with the integral dunnage inflated;

FIG. 6a is a cut-away depiction of an embodiment containing an item in which the dunnage balloons are affixed to semi-rigid molded members, the dunnage in this drawing uninflated;

FIG. 6b is a cut-away depiction of the embodiment shown in FIG. 6a, in this case shown with the dunnage inflated thereby retaining the item within the molded members;

### DETAILED DESCRIPTION OF THE INVENTION

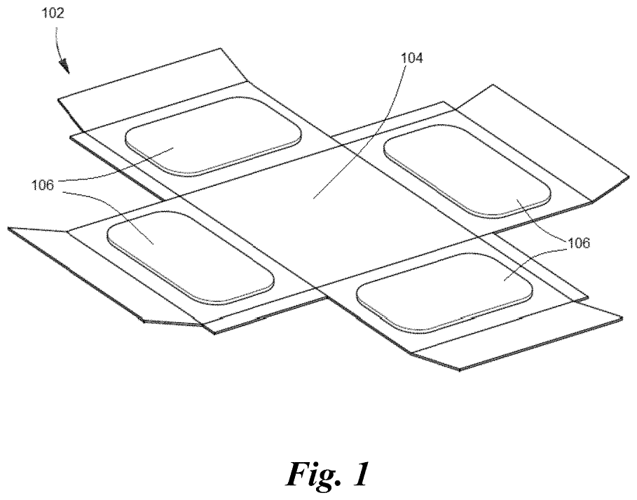

Turning now to the drawings, FIG. 1 depicts a container prior to assembly according to an embodiment of the invention. This container 102 comprises a sheet of cardboard 104 cut out for forming a box affixed to which are four deflated balloons 106. Embodiments affix balloons 106 to cardboard cutout 104 with glue. Embodiments employing dunnage balloons of Mylar® may utilize contact cement, such as Weldwood® from DAP Products Inc. of Baltimore, Md. as glue to affix the balloons 106 to cardboard 104.

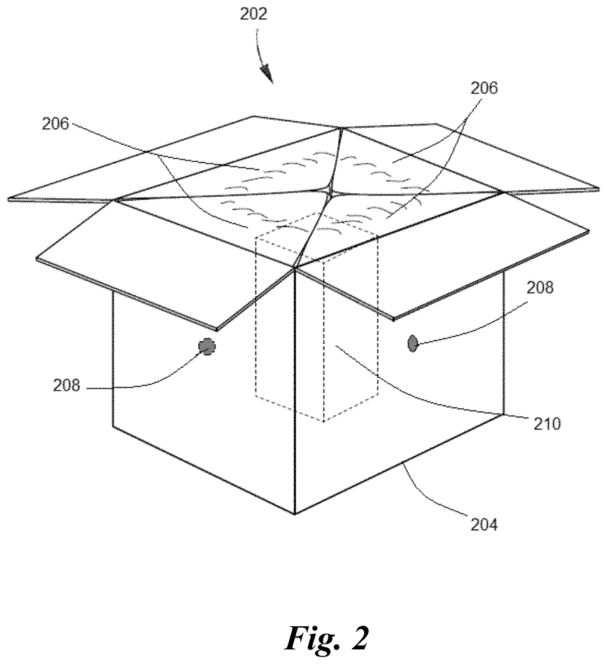

FIG. 2 depicts an embodiment of an assembled container 202 containing an item for shipment. Cardboard box 204 contains dunnage balloons 206 such as depicted in regards FIG. 1, balloons 206 here having been inflated through valve stems protruding though openings 208 (two shown) in box 204. Inflated balloons 206 completely enclose shipping item 210 within the interior of container 202, restraining and cushioning item 210 during shipment, thereby protecting item 210 from damage.

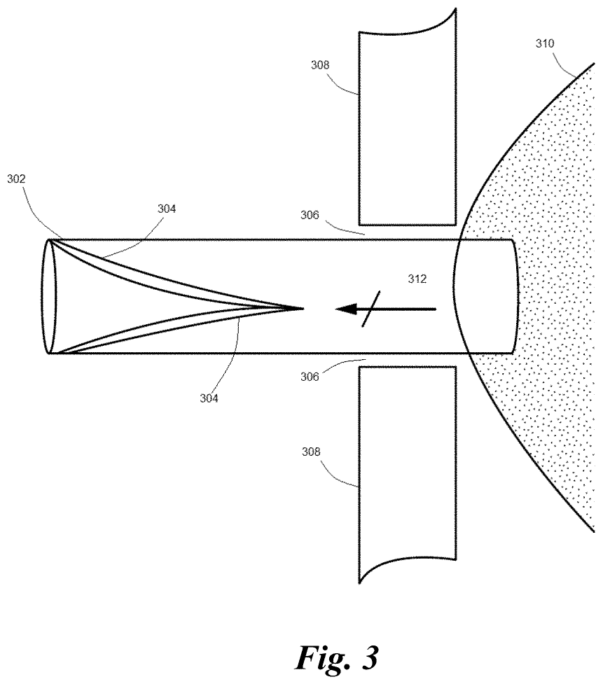

FIG. 3 is a diagram showing the operative parts of a valve stem for a dunnage balloon in an embodiment of the invention. Valve stem 302 passes through hole 306 in container wall 308, providing a conduit into the interior of dunnage balloon 310 within the container. Valve stem 302 contains a reed valve comprised of two opposing semi-rigid valve pieces 304 of sheet plastic, disposed within valve stem 302 such that positive pressure from one end of valve stem 302 causes sheet plastic valve pieces 304 to press together preventing gas escape from an inflated balloon 310, as indicated by the crossed arrow line 312.

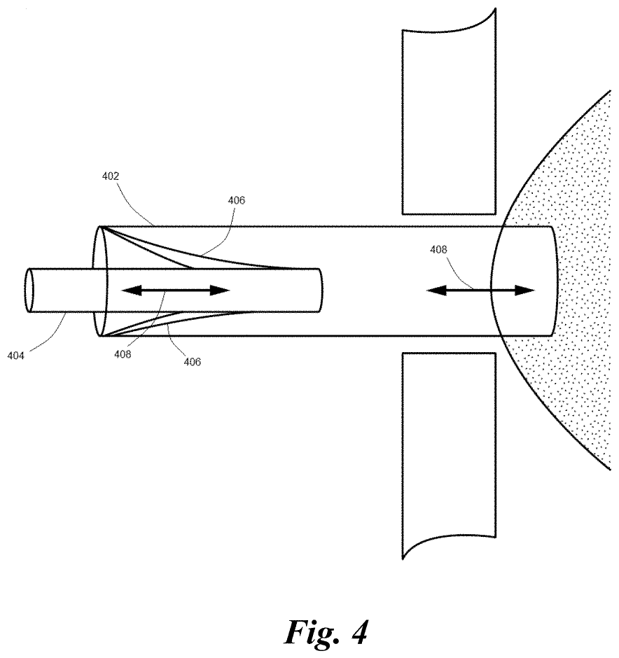

FIG. 4 illustrates inflation or deflation of the dunnage balloon in the embodiment portrayed in FIG. 3. To inflate or deflate the balloon, a tubular conduit 404 is inserted into valve stem 402. Conduit 404 spreads the semi-rigid plastic sheets 406 comprising the reed valve, opening sheets 406 to permit passage of air into and out of the balloon, as indicated by the double-headed arrows 408, whereby the balloon may be inflated to serve as dunnage and deflated for reuse.

As will be appreciated by those in the art, other embodiments of the invention may use other forms of valve to retain air in the inflated dunnage balloons. Such valves include but are not limited to self-sealing flap valves, gate valves and umbrella valves. What is needed is that the valves employed in the invention seal the air or other gas with which the bag is inflated, reasonably preventing substantial leakage from an inflated bag and permitting deflation by the user after the device has been used for shipment of an item, readying the device for reinflation with the next item to be shipped.

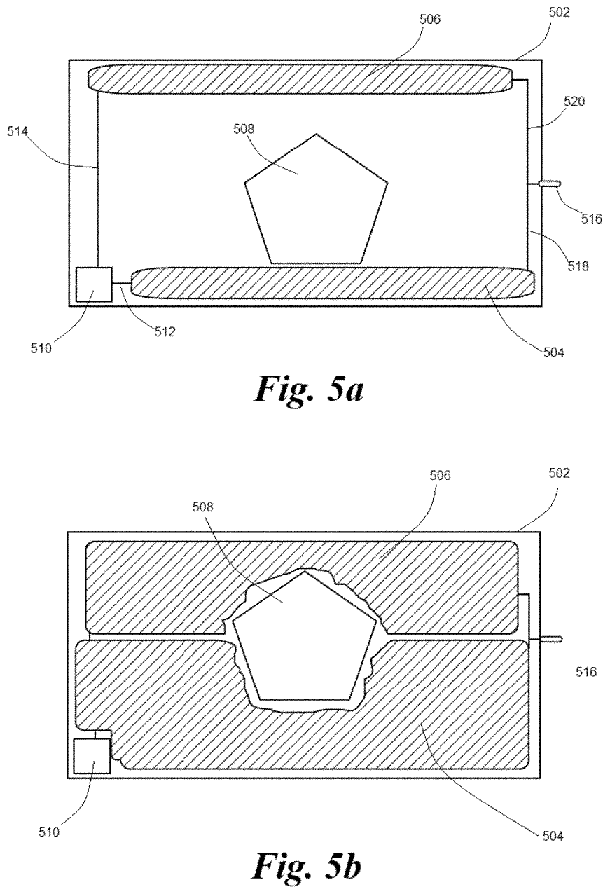

FIG. 5a is a depiction of an embodiment of the invention that uses an internal source of compressed gas such as an air pump or a tank of compressed gas. In container 502 are dunnage balloons 504, 506 affixed to opposing walls of container 502. In this figure, dunnage balloons 504, 506 are uninflated. Placed within container 502, between balloons 504, 506 is shipment item 508. Compressed gas source 510 is affixed within container 502, with feeder lines 512, 514 for providing compressed gas to inflate balloons 504 and 506 respectively. In this embodiment, release valve 516, operatively connected by release tubing 518, 520 to balloons 504, 506 respectively, protrudes through the wall of container 502 to permit a user to deflate the dunnage.

In FIG. 5b, balloons 504, 506 have been inflated by compressed gas source 510, by way of feeder lines 512, 514, to surround and secure item 508 within container 502 for shipment. When container 502, containing item 508, is delivered to its destination, balloons 504, 506 may be deflated by the recipient by opening release valve 516. The recipient may then remove item 508 and redeploy container 502 with its inflatable dunnage for further shipments.

Compressed gas source 510 may be a small, battery powered air compressor. Many such small compressors, such as the Enusic™ 7800 mAh Cordless 25 L/min 150 PSI Portable Air Compressor Pump, are widely available online and most are adaptable for employment in the present invention. After placement of item 508 within container 502, as illustrated in FIG. 5a, the user will operate the battery powered air compressor until the dunnage balloons are sufficiently inflated to secure the item for shipment, as shown in FIG. 5b. For embodiments employing a battery powered air compressor, recharging or battery replacement will be required with repeated use of the invention.

Compressed gas source 510 may alternatively be a small manually operated air pump, such as the double action hand pump, item 23115, from Texsport Inc. of Houston, Tex. In such embodiments, after placement of an item in the container, as illustrated in FIG. 5a, the user will operate the hand pump to inflate the dunnage balloons until the item is sufficiently restrained for shipment, as illustrated in FIG. 5b.

In yet other embodiments, compressed gas source 510 may be a replaceable or refillable small tank of compressed gas, such as a replaceable cartridge of carbon dioxide, breached and delivered by a device such as the CO2yre from Oxford Products Ltd. of Witney, Oxfordshire, U.K. To operate the device for filling the inflatable dunnage, a threaded sealed compressed gas cartridge is screwed into a receptable in the device that pierces the seal of the cartridge, the device restraining the pressure inside the cartridge by a valve. The user may then open the valve to release the gas from the device. In the depicted embodiment, the gas released from this compressed gas source 510 is then delivered by connected feeder lines 512, 514 to inflate dunnage balloons 504, 506. When the dunnage balloons are sufficiently inflated, the user closes the valve on the device. Advantageously for cargo presenting a fire hazard, such as flammable material or lithium batteries, embodiments may utilize tanks of fire retardant gas, for example a brominated haloalkane like Halon 1211, or alternatively FM-200 fire suppressant from The Chemours Company, with U.S. headquarters in Wilmington, Del., to inflate the dunnage, thereby reducing the risk associated with such hazardous cargo.

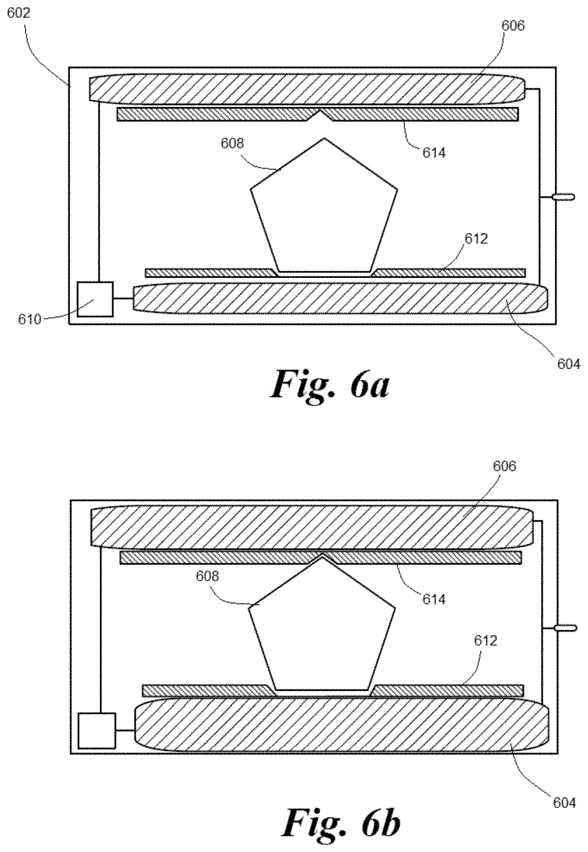

Turning now to FIG. 6a, uninflated dunnage balloons 604, 606 are affixed to opposing walls of container 602. Semi-rigid members 612, 614, molded in a configuration specifically to receive shipping item 608, are disposed or attached to balloons 604, 606 respectively, distal the walls to which the balloons are attached. Using compressed gas source 610, the user can inflate balloons 604, 606, thereby pressing molded rigid members 612, 614 against item 608, holding and restraining the item for shipment. When the container 602 arrives at its destination, balloons 604, 606 can be deflated in a similar manner as described in relation to FIG. 5b above, removed from the molded members 612, 614 and removed from the container 602. Container 602 with its integrated dunnage balloons 604, 606 and, optionally, rigid molded members 612, 614, may then be reused for shipping other items.

Although embodiments of the invention have been described above, persons of skill in the art will appreciate that variations and elaborations of the apparatus may be made that are nonetheless within the scope of the invention. For example, embodiments may employ one or more planar semi-rigid members, in contrast with the molded members described in respect to FIGS. 6a and 6b, the planar member or members suitable for restraining relatively flat items. In other embodiments, the dunnage balloons themselves may be configured so that their inflated shape conforms to the particular shape of an specific item to be shipped, enabling the nesting of the item within the inflated shaped dunnage. Embodiments of the invention may employ at least one balloon with a plurality of chambers, multiple chambers providing added assurance of dunnage protection in the event that one of the chambers is breached. All such embodiments are contemplated by the present invention.

While the invention has been described with a certain degree of particularity, it should be recognized that elements thereof may be altered by persons skilled in the art without departing from the spirit and scope of the invention. Accordingly, the present invention is not intended to be limited to the specific forms set forth in this specification, but on the contrary, it is intended to cover such alternatives, modifications and equivalents as can be reasonably included within the scope of the invention. The invention is limited only by the following claims and their equivalents.

I claim:

1. A container with integral inflatable dunnage, the container comprising
a box with walls, the box having an exterior and an interior,
an inflatable dunnage balloon affixed to one of the walls interior to the box, the inflatable dunnage balloon having an interior,
a means for inflating the inflatable dunnage balloon, and
a means for deflating the inflatable dunnage balloon.

2. The container with integral inflatable dunnage according to claim 1, in which the inflatable dunnage balloon is configured to expand and retain an item within the box when inflated.

3. The container with integral inflatable dunnage according to claim 1, in which the means for inflating the inflatable dunnage balloon comprises at least one gas valve communicating from the exterior of the box to the interior of the inflatable dunnage balloon.

4. The container with integral inflatable dunnage according to claim 1, in which the means for deflating the inflatable dunnage balloon comprises at least one gas valve communicating from the exterior of the box to the interior of the inflatable dunnage balloon.

5. The container with integral inflatable dunnage according to claim 1, in which the means for inflating the inflatable dunnage balloon comprises an air pump operatively connected to provide compressed air to the interior of the inflatable dunnage balloon.

6. The container with integral inflatable dunnage according to claim 1, in which the means for inflating the inflatable dunnage balloon comprises a tank of compressed gas operatively connected to provide compressed gas to the interior of the inflatable dunnage balloon.

7. The container with integral inflatable dunnage according to claim 1, further comprising a semi-rigid member, the semi-rigid member disposed within the interior of the box and abutting the inflatable dunnage balloon and distal to the one of the walls to which the inflatable dunnage balloon is affixed.

8. The container with integral inflatable dunnage according to claim 7, in which the semi-rigid member is molded to conform to an item to be retained within the box.

9. A container with integral inflatable dunnage, the container comprising
a box with walls, the box having an exterior and an interior,
a plurality of inflatable dunnage balloons, each inflatable dunnage balloon affixed to one of the walls interior to the box,
a means for inflating the plurality of inflatable dunnage balloons, and
a means for deflating the plurality of inflatable dunnage balloons.

10. An article for assembly into a container with integral inflatable dunnage, the article comprising
a cardboard sheet configured to be folded into a box, the cardboard sheet having a top side and a bottom side,
an inflatable dunnage balloon having an interior, the inflatable dunnage balloon affixed to the top side of the cardboard sheet,
a means for inflating the inflatable dunnage balloon, and
a means for deflating the inflatable dunnage balloon.

11. The article for assembly into the container with integral inflatable dunnage according to claim 10, wherein the means for inflating the inflatable dunnage balloon and the means for deflating the inflatable dunnage balloon comprises a gas valve communicating from the bottom side of the cardboard sheet to the interior of the inflatable dunnage balloon.
